(19) United States
(12) Patent Application Publication
(10) Pub. No.: US 2011/0002732 A1
(43) Pub. Date: Jan. 6, 2011

(54) Rotation Control Device for a Tool

(76) Inventor: Cheng-Wei SU, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/621,490

(22) Filed: Nov. 18, 2009

(30) Foreign Application Priority Data
Jul. 3, 2009 (TW) 098122619

(51) Int. Cl. F16D 1/00

(52) U.S. Cl. 403/325

(57) ABSTRACT

A rotation control device for a tool is disposed between a handle and a tool head and essentially comprises two ratchet wheels, a spring and two C-shaped snap rings. The two ratchet wheels are symmetrically arranged, so that when being pressed, the respective ratchet wheels will be subjected to the same force and move the same distance, thus making the engagement between the ratchet wheels and the tool head more assured while avoiding the stuck fault and improving the convenience in use.

### BACKGROUND OF THE INVENTION

1. Field of the Invention

The present invention relates to a tool; and more particularly to a rotation control device for a tool.

2. Description of the Prior Art

Referring to FIGS. 1-2, a conventional rotational prying tool 10 comprises a handle 11, a rotating block 12 and a prying head 13. The rotating block 12 is disposed in the handle 11, and the prying head 13 is mounted on both the handle 11 and the rotating block 12. The prying head 13 is provided with an engaging portion 131 on an inner surface thereof while the rotating block 12 is provided with a engaging portion 121 on an outer surface thereof, and the engaging portion 131 can be engaged with the engaging portion 121. Between one side of the rotating block 12 and the prying head 13 is disposed a spring 14, and the other side of the rotating block 12 is sealed with a seal cover 15. When the engaging portion 121 of the rotating block 12 is engaged with the engaging portion 131 of the prying head 13, the prying head 13 of the tool 10 can be used to perform the prying operation. When the seal cover 15 presses against the rotating block 12, causing compression of the spring 14, the engaging portion 121 of the rotating block 12 will be disengaged from the engaging portion 131 of the prying head 13, causing idle rotation between the rotating block 12 and the prying head 13, at this moment, the angle of the prying head 13 can be adjusted. However, the rotating block 12 engages with the prying head 13 while being elastically pressed by the spring 14, it is not easy for the engaging portion 121 of the rotating block 12 and the engaging portion 131 of the prying head 13 to engage with each in a very exact and precise manner, which will cause inconvenience in use, or even stuck fault. In addition, the single-flank engagement cannot provide enough engaging force, consequently reducing the output torque.

The present invention has arisen to mitigate and/or obviate the afore-described disadvantages.

### SUMMARY OF THE INVENTION

The primary objective of the present invention is to provide a rotation control device for a tool which can avoid the stuck fault and improve convenience in use.

In order to achieve the above objective, a rotation control device for a tool in accordance with the present invention is disposed between a handle and a tool head.

The handle is formed with two opposite parallel assembling portions at one end thereof, each of the two assembling portions is defined with a first through hole, each of the first through holes is provided with a first ratchet portion on an inner periphery thereof, and an annular groove close to the outer edge of the inner periphery thereof.

The tool head is provided at one end thereof with a working portion in the form of a prying head, and the other end of the tool head is defined with a second through hole, the second through hole is provided with a second ratchet portion on an inner periphery thereof, the end of the tool head having the second through hole is inserted between the two assembling portions, and the second through hole of the tool head is in communication with the two first through holes of the handle.

The rotation control device comprises: two ratchet wheels, a spring and two C-shaped snap rings.

The two ratchet wheels each include a ratchet portion on an outer periphery thereof, and the two ratchet wheels are disposed in the respective through holes of the assembling portions of the handle, and the ratchet portions of the ratchet wheels are simultaneously engaged with the respective first ratchet portions of the handle and the second ratchet portion of the tool head.

The spring has its two ends pressed against the two ratchet wheels.

The two C-shaped snap rings are disposed in the respective annular grooves of the assembling portions of the handle.

By such arrangements, the two ratchet wheels can be pressed to compress the spring oppositely in such a manner that the two ratchet wheels can be fully engaged with the second ratchet portion of the tool head, so that the tool head can be rotated to a desired angle. The two ratchet wheels are symmetrically arranged, so that the two ratchet wheels can be subjected to the same force and move the same distance, thus avoiding the stuck fault while improving the convenience in use.

### BRIEF DESCRIPTION OF THE DRAWINGS

FIG. 1 is a cross-sectional view of a conventional prying tool, showing that the rotating block is engaged with the prying head;

FIG. 2 is a cross-sectional view of the conventional prying tool, showing that the rotating block is disengaged from the prying head;

FIG. 3 is an exploded view of a rotation control device for a tool in accordance with the present invention;

FIG. 4 is an assembly view of the rotation control device for a tool in accordance with the present invention;

FIG. 5 is a cross-sectional view showing the engaging state of the rotation control device for a tool in accordance with the present invention;

FIG. 6 is a cross-sectional view showing that the ratchet wheels are fully engaged with the tool head in accordance with the present invention;

FIG. 7 is an operational view of the rotation control device for a tool in accordance with the present invention;

FIG. 8 is an exploded view showing that the tool head of the rotation control device for a tool in accordance with the present invention is integrally formed with a connecting portion;

FIG. 9 is an assembly view of FIG. 8;

FIG. 10 is an operational view of FIG. 9;

FIG. 11 is an exploded view showing that the rotation control device for a tool in accordance with the present invention is not provided with the seal covers and the positioning pins;

FIG. 12 is a cross-sectional view of the rotation control device for a tool in accordance with the present invention which is not provided with the seal covers; and

FIG. 13 is a cross-sectional view showing the engaging state of the rotation control device for a tool in accordance with the present invention which is not provided with the seal covers.

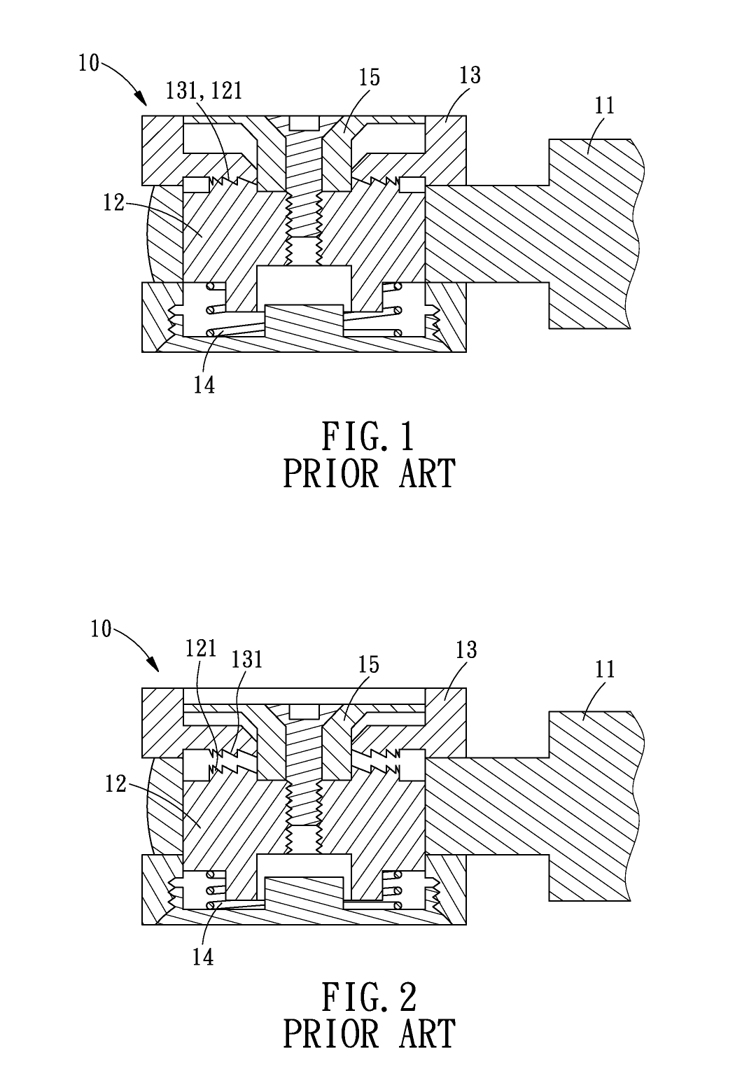

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

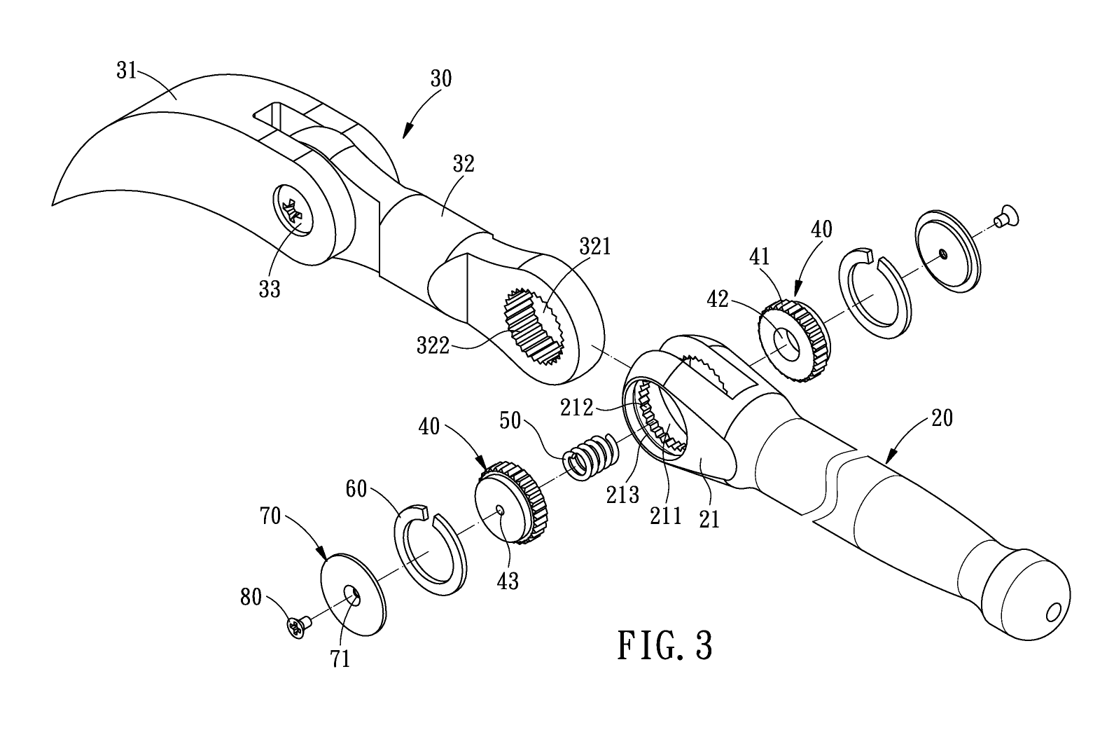

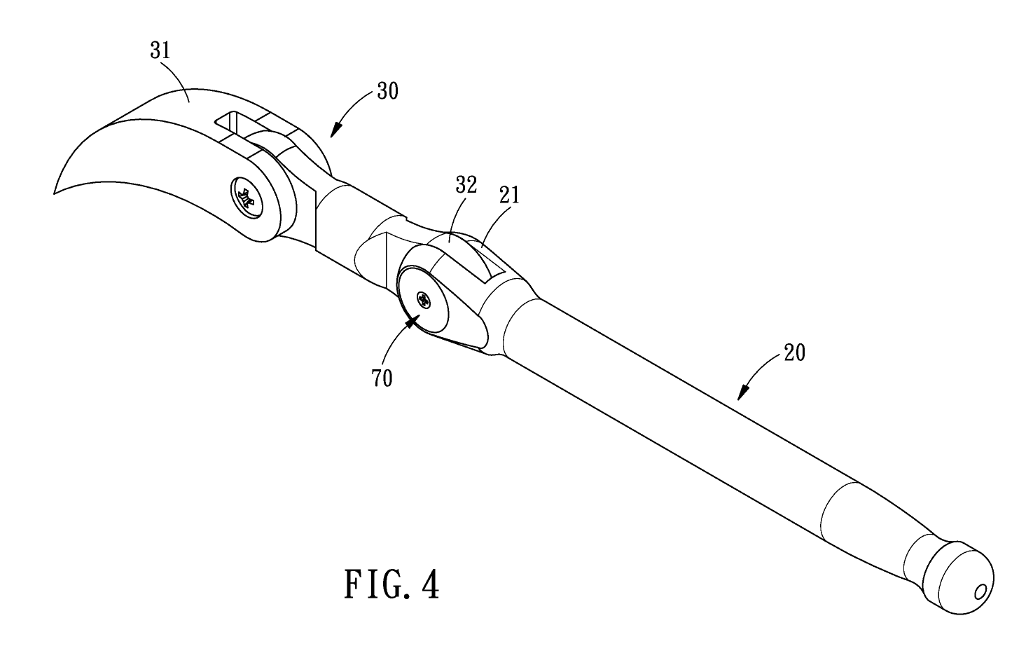

Referring to FIGS. 3-4, a rotation control device for a tool in accordance with a preferred embodiment of the present invention is disposed between a handle 20 and a tool head 30.

The handle 20 is formed with two opposite parallel assembling portions 21 at one end thereof. Each of the two assembling portions 21 is defined with a first through hole 211. Each of the first through holes 211 is provided with a first ratchet portion 212 on an inner periphery thereof, and an annular groove 213 close to the outer edge of the inner periphery thereof.

The tool head 30 includes a working portion 31 at one end thereof, and the other end of the tool head 30 is pivotally connected to a connecting rod 32 by a threaded element 33. The connecting rod 32 is defined with a second through hole 321 and a second ratchet portion 322 on an inner periphery of the second through hole 321. The connecting rod 32 of the tool head 30 is disposed between the two assembling portions 21 of the handle 20, and the second through hole 321 of the tool head 30 is in communication with the two first through holes 211 of the handle 20. In the present embodiment, the working portion 31 is in the form of a prying head.

The rotation control device in accordance with the present invention comprises: two ratchet wheels 40, a spring 50, two C-shaped snap rings 60, two seal covers 70 and two positioning pins 80.

Each of the two ratchet wheels 40 is cylinder-shaped and provided with a ratchet portion 41 on an outer periphery thereof. In addition, each of the two ratchet wheels 40 is formed with a receiving groove 42 and a positioning hole 43 in both opposite end surface thereof. The two ratchet wheels 40 are oppositely disposed in the respective first through holes 211 of the assembling portions 21 of the handle 20 in such a manner that the receiving grooves 42 of the two ratchet wheels 40 are located opposite each other, and the ratchet portions 41 of the two ratchet wheels 40 are simultaneously engaged with the respective first ratchet portions 212 of the handle 20 and the second ratchet portion 322 of the tool head 30.

The spring 50 has its two ends pressed against the receiving grooves 42 of the two ratchet wheels 40, so that the two ratchet wheels 40 can be pushed back to their original positions by the spring 50 after movement.

The two C-shaped snap rings 60 are disposed in the respective annular grooves 213 of the assembling portions 21 of the handle 20 for preventing the two ratchet wheels 40 from disengaging from the respective first through holes 211 of the assembling portions 21 of the handle 20.

The two seal covers 70 each formed a through hole 71 are used to cover the respective first through holes 211 of the assembling portions 21 of the handle 20 and press against the respective ratchet wheels 40.

The two positioning pins 80 are inserted through the respective through holes 71 of the two seal covers 70 and positioned in the respective positioning holes 43 of the ratchet wheels 40.

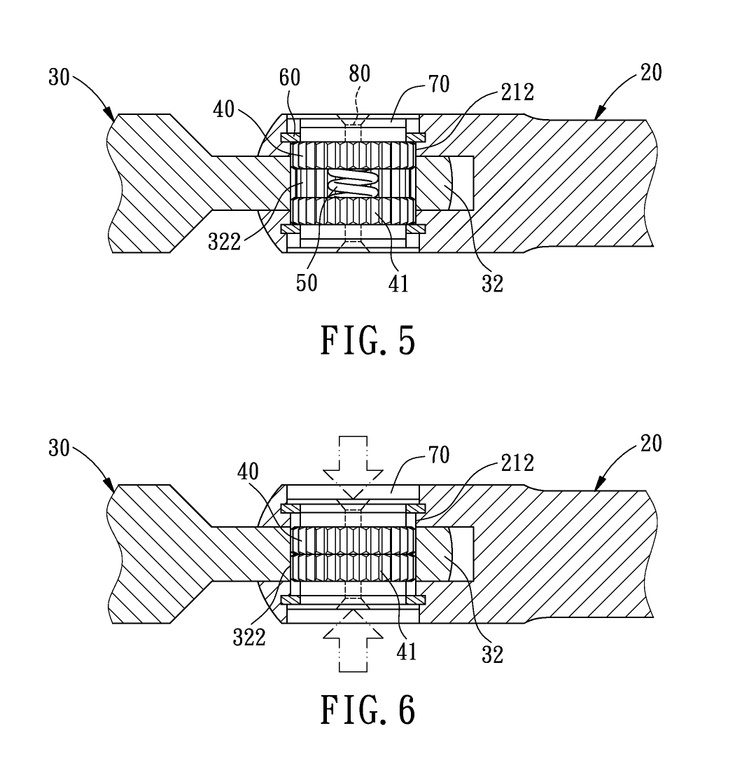

The aforementioned is the summary of the positional and structural relationship of the respective components of the preferred embodiment in accordance with the present invention. Under normal conditions, the spring 50 pushes the two ratchet wheels 40 outwards to make the ratchet portions 41 of the two ratchet wheels 40 simultaneously engage with the respective first ratchet portions 212 of the handle 20 and the second ratchet portion 322 of the connecting rod 32 of the tool head 30, so that the two ratchet wheels 40 can be engaged with both the handle 20 and the tool head 30, and the tool head 30 can be fixed relative to the handle 20 and operated by the user as shown in FIG. 5.

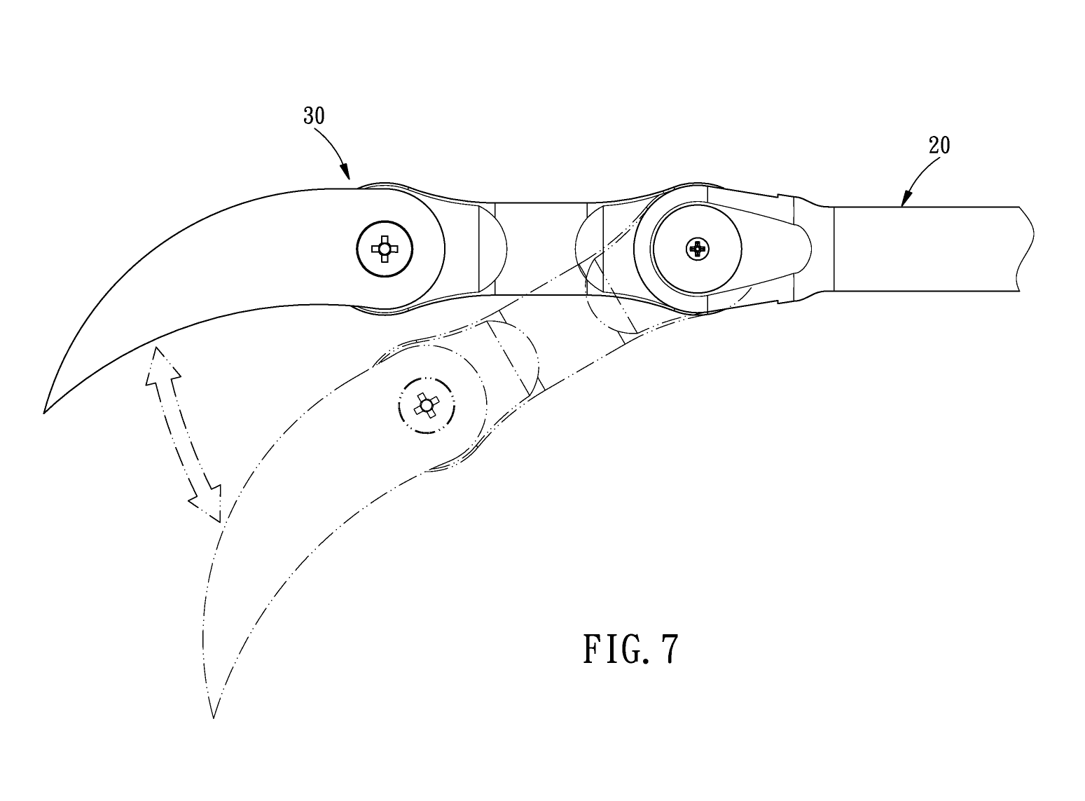

To adjust the angle of the tool head 30, the two seal covers 70 can be pressed to force the two ratchet wheels 40, and then the two ratchet wheels 40 will compress the spring 50. When the two ratchet wheels 40 move inwards, the ratchet portions 41 of the two ratchet wheels 40 will disengage from the first ratchet portions 212 of the handle 20 and fully engage with the second ratchet portion 322 of the tool head 30, as shown in FIG. 6, so that the two ratchet wheels 40 can be rotated without being stopped by the first ratchet portions 212 of the handle 20, namely, the tool head 30 can be rotated synchronously with the two ratchet wheels 40 and thus it can be adjusted to a desired angle. As shown in FIG. 7, the user will stop pressing the two seal covers 70 until the tool head 30 is adjusted to the desired angle, at this moment, the spring 50 will elastically restore to its original shape and push the two ratchet wheels 40 back to their original positions of engaging with both the first ratchet portions 212 of the handle 20 and the second ratchet portion 322 of the tool head 30, so that the user can use the tool head 30 which has been adjusted to the desired angle to carry out prying operation.

Additionally, since the present invention utilizes the two symmetrically-arranged ratchet wheels 40 to press the spring 50, when pressing the spring 50, the respective ratchet wheels 40 are subjected to the same force and move the same distance, thus avoiding the deviation of the ratchet wheels 40 and the occurrence of ratchet stuck fault resulted from it. Due to the two symmetrically-arranged seal covers 70, the user can press the respective seal covers 70 with two fingers synchronously, thus facilitating force application while making it more stable to hold the handle 20.

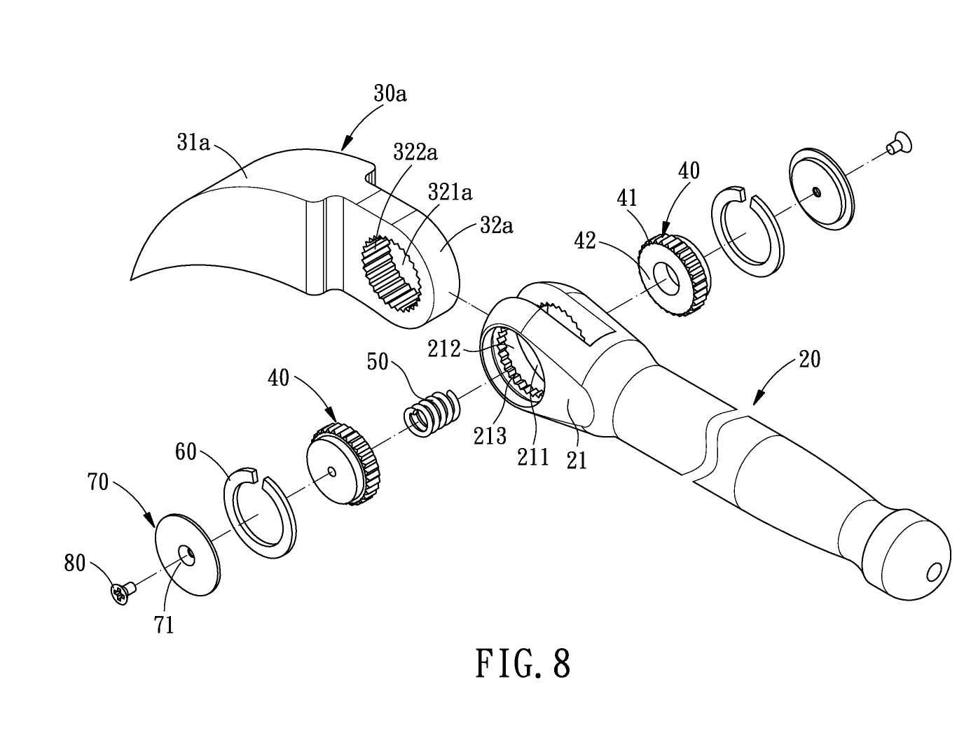

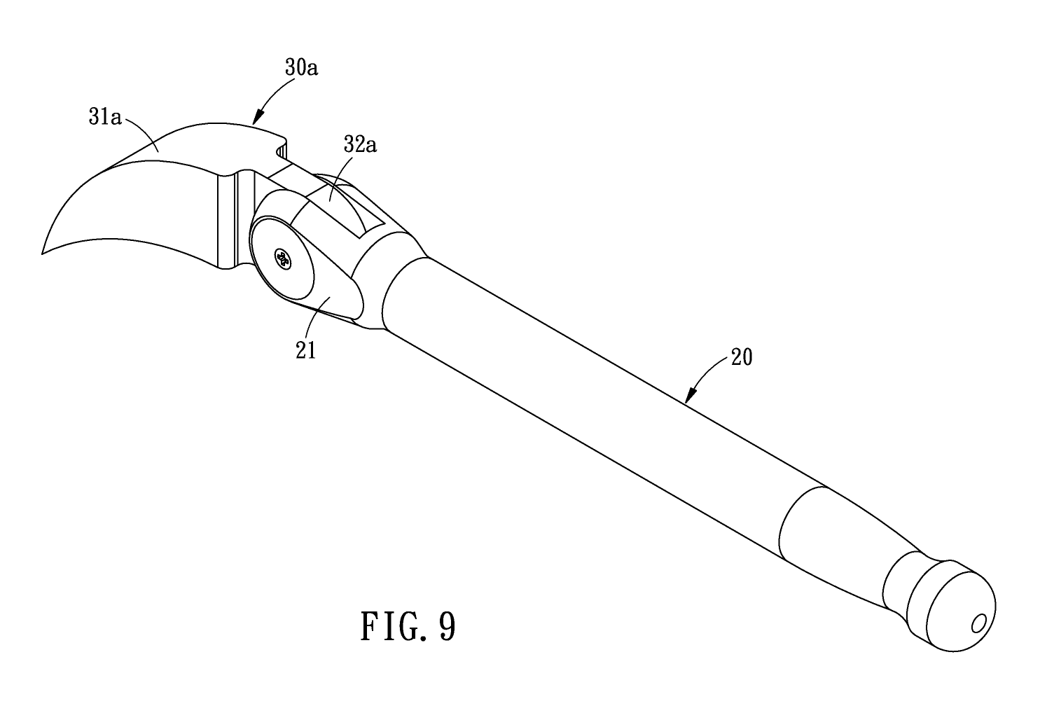

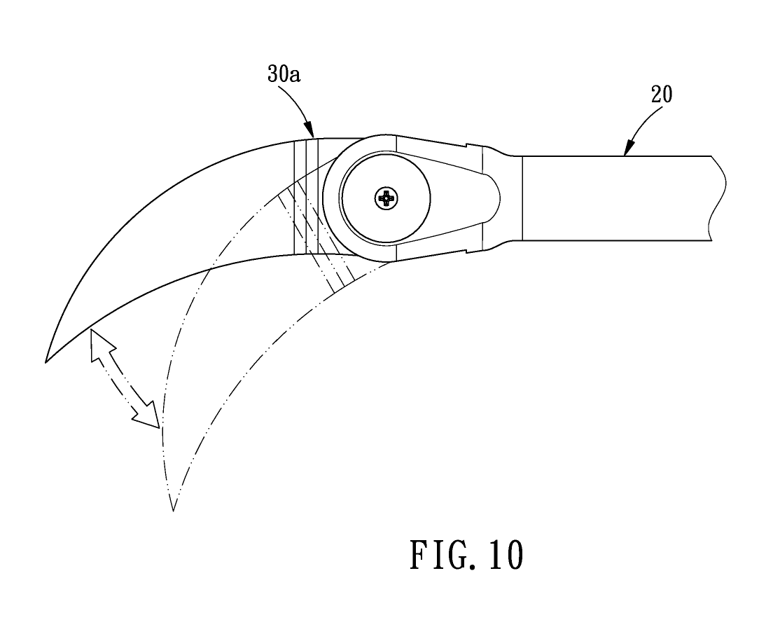

The tool head 30 in the present embodiment is formed by pivotally connecting the working portion 31 to the connecting rod 32. The rotation control device of the present invention is provided for the connecting rod 32 to drive the working portion 31 to rotate, the connecting rod 32 can extend the length of the tool. Referring to FIGS. 8-10, in another embodiment of the present invention, the working portion 31a of the tool head 30a is also in the form of a prying head as described in the above embodiment, but the working portion 31a is integrally formed with a flat connecting portion 32a which is directly inserted between the two assembling portions 21 of the handle 20, the second through hole 321a and the second ratchet portion 322a are formed at the connecting portion 32a of the tool head 30a. The rotation control device in the present embodiment is disposed between the tool head 30a and the handle 20, so that the rotation control device can directly drive the tool head 30a to rotate and offer the same functions as described above.

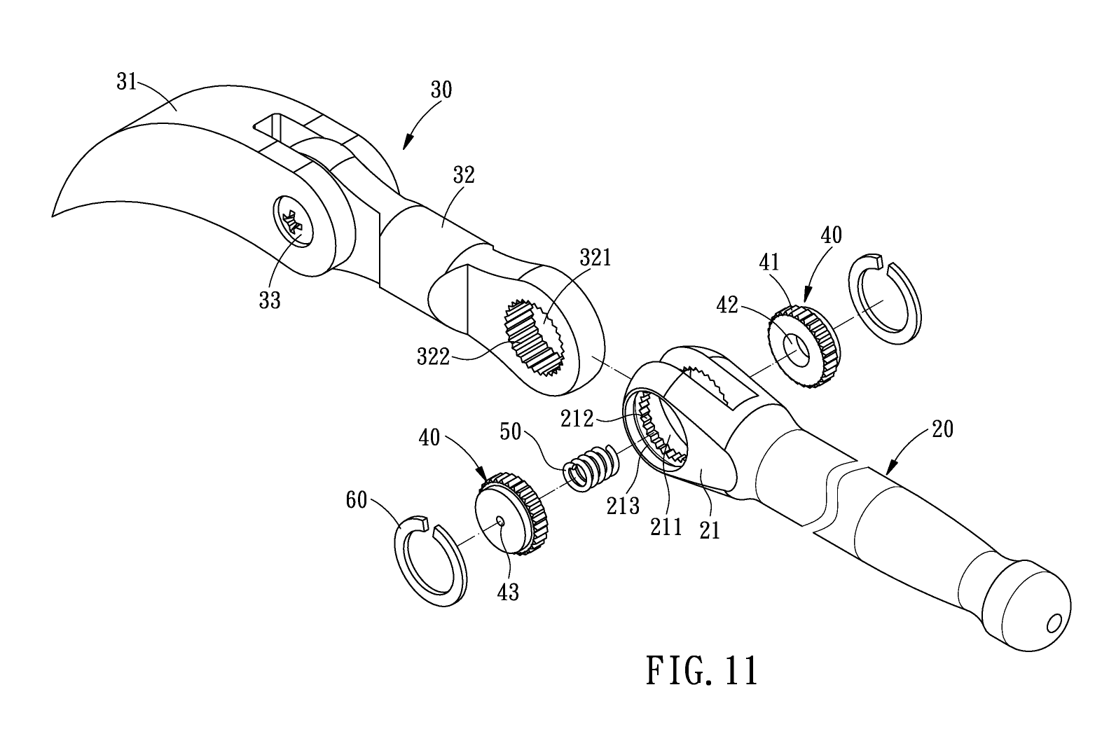

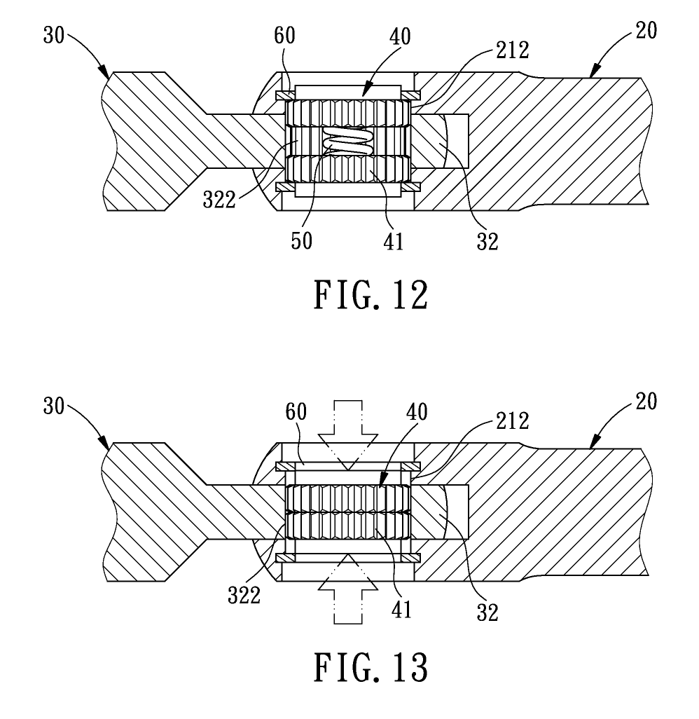

Further referring to FIGS. 11-13, alternatively, the rotation control device of the present invention can also not be provided with such two seal covers 70, but it can also realize the above functions by directly pressing the two ratchet wheels 40.

While we have shown and described various embodiments in accordance with the present invention, it is clear to those skilled in the art that further embodiments may be made without departing from the scope of the present invention.

What is claimed is:

1. A rotation control device for a tool being disposed between a handle and a tool head, wherein:
the handle is formed with two opposite parallel assembling portions at one end thereof, each of the two assembling portions is defined with a first through hole, each of the first through holes is provided with a first ratchet portion on an inner periphery thereof, and an annular groove close to an outer edge of the inner periphery thereof;
the tool head is provided at one end thereof with a working portion in the form of a prying head, and the other end of the tool head is defined with a second through hole, the second through hole is provided with a second ratchet portion on an inner periphery thereof, the end of the tool head having the second through hole is inserted between the two assembling portions, and the second through hole of the tool head is in communication with the two first through holes of the handle;
the rotation control device comprises: two ratchet wheels, a spring and two C-shaped snap rings:
the two ratchet wheels each include a ratchet portion on an outer periphery thereof, and the two ratchet wheels are disposed in the respective through holes of the assembling portions of the handle, and the ratchet portions of the ratchet wheels are simultaneously engaged with the respective first ratchet portions of the handle and the second ratchet portion of the tool head;
the spring has its two ends pressed against the two ratchet wheels; and
the two C-shaped snap rings are disposed in the respective annular grooves of the assembling portions of the handle.

2. The rotation control device for a tool as claimed in claim 1, wherein the tool head further includes a connecting rod which is pivotally connected to the other end thereof opposite the working portion by a threaded element, the second through hole is defined in the connecting rod.

3. The rotation control device for a tool as claimed in claim 1, wherein the tool head includes a connecting portion at the other end thereof opposite the working portion, the connecting portion is integrally connected to the working portion.

4. The rotation control device for a tool as claimed in claim 1, wherein each of the ratchet wheels is formed with a receiving groove in one end surface thereof, the two ratchet wheels are oppositely arranged in such a manner that the receiving grooves of the two ratchet wheels are located opposite each other, the two ends of the spring are pressed against the respective receiving grooves of the two ratchet wheels.

5. The rotation control device for a tool as claimed in claim 1 further comprising two seal covers used to cover the respective first through holes of the assembling portions and press against the respective ratchet wheels, each of the seal covers including a through hole, two positioning pins being inserted through the respective through holes of the seal covers and positioned in positioning holes of the respective ratchet wheels.
